(19) United States
(12) Patent Application Publication
(10) Pub. No.: US 2025/0296455 A1
(43) Pub. Date: Sep. 25, 2025

(54) ROAD CONSTRUCTION MACHINE WITH WIRELESS ENERGY TRANSMISSION

(71) Applicant: JOSEPH VÖGELE AG, Ludwigshafen/Rhein (DE)

(72) Inventor: Moritz RÖSEL, Ludwigshafen (DE)

(73) Assignee: JOSEPH VÖGELE AG, Ludwigshafen/Rhein (DE)

(21) Appl. No.: 19/084,035

(22) Filed: Mar. 19, 2025

(30) Foreign Application Priority Data
Mar. 19, 2024 (EP) 24164397.2

(51) Int. Cl. B60L 53/126; B60L 50/60; B60L 53/124; H02J 50/00

(52) U.S. Cl. CPC B60L 53/126; B60L 50/66; B60L 53/124; H02J 50/005; B60L 2200/40

(57) ABSTRACT

A road construction machine such as a road paver for producing a paving layer from a paving material or a feeder vehicle for supplying the road paver with paving material. The road construction machine includes an electric drive for driving the road construction machine and/or at least one electrical consumer. The road construction machine further includes a receiving device for electrical energy. The receiving device is configured to wirelessly receive electrical energy from an external transmitting device and to forward the electrical energy to the electric drive and/or the electric consumer.

### CROSS-REFERENCE TO RELATED APPLICATIONS

This application claims foreign priority benefits under 35 U.S.C. § 119(a)-(d) to European patent application No. 24164397.2 filed on Mar. 19, 2024, which is hereby incorporated herein by reference in its entirety.

### TECHNICAL FIELD

The present disclosure relates to a road construction machine, a system for wirelessly supplying a road construction machine with electrical energy, and a method for operating a road construction machine.

### BACKGROUND

Road construction machines are generally known from the prior art. For example, these can be a road paver for producing a paving layer from a paving material or a feeder vehicle for supplying the road paver with the paving material.

Conventional road construction machines typically use diesel fuel as their energy source. Current road construction machines with diesel tanks are adapted to be driven for a maximum of ten hours and to cover a certain range with a full tank of fuel. In this case, it is assumed that the road construction machine is used at high to maximum capacity. Furthermore, it is already known from prior art that road construction machines can be operated electrically. However, the lower range of the road construction machine is problematic when it comes to electrified road construction machines. When using an energy storage device for an electrified road construction machine, such as a battery, for example a rechargeable battery (battery), as an energy source and electric drive chain, significantly larger and heavier energy storage devices would have to be used to achieve similar ranges due to the lower energy density of a battery compared to the energy density of diesel fuel. Since this can only be realized to a limited extent without drastically increasing the size of the road construction machine, the consequence is a significant reduction in the working time or amount of work that an electrified road construction machine can perform. Due to the limited range of an electrified road construction machine having a battery as its energy source, the battery would have to be replaced or recharged once or several times. Alternatively, the road construction machine with the empty battery would have to be driven away from the construction site so that another road construction machine with a charged battery could be used as a replacement. Consequently, the construction site would have to be interrupted for a short or long period of time. This is not only disadvantageous for the energy efficiency of the road construction machine (e.g. the screed and material conveyors would have to be warmed up again after the interruption), but also for the paving quality. Interruptions can potentially cause start-up marks, segregation, temperature drops in the mix, compaction problems, and even cooling and solidification of the paving material in the road construction machine.

### SUMMARY

Starting from the known prior art, the technical problem to be solved is to provide a road construction machine, a system for wirelessly supplying a road construction machine with electrical energy, or a method for operating a road construction machine that eliminates or at least reduces the above disadvantages. Ideally, the range and/or operating time of the road construction machine should be increased.

According to the disclosure, this problem is solved by a road construction machine according to claim 1, a system for wirelessly supplying a road construction machine with electrical energy according to claim 9 or a method for operating a road construction machine according to claim 14.

Embodiments of the disclosure are defined in the claims.

According to one embodiment of the disclosure, a road construction machine is provided. The road construction machine is a road paver for producing a paving layer from a paving material or a feeder vehicle for supplying the road paver with paving material. The road construction machine comprises an electric drive for driving the road construction machine and/or at least one electrical consumer. The road construction machine further comprises a receiving device for electrical energy. The receiving device is configured to wirelessly receive electrical energy from an external transmitting device and to forward the electrical energy to the electric drive and/or the electrical consumer. This makes it possible to supply the road construction machine with electrical energy in a particularly simple and reliable manner. The electric drive and/or the consumers can be connected to the receiving device by means of a cable. The electric drive and/or the consumers can be supplied with energy directly by the receiving device. This can eliminate the need for a storage device, in particular between the receiving device and the electric drive and/or consumer. Ideally, this can reduce the weight of the road construction machine and/or make the road construction machine particularly compact. Optionally, the space required for other components of the road construction machine, which is saved due to the storage device, can be used. Ideally, an extension of the operating time and/or range of the road construction machine can be achieved. By not having to operate the road construction machine using a storage device, and in particular by being able to supply the road construction machine with energy directly through the receiving device, it is possible to operate the road construction machine independently of a storage device charging capacity. For example, it is possible to avoid driving the road construction machine to a stationary charging station to charge the storage device there. This means that the road construction machine can be used efficiently. Ideally, it may be possible to avoid the road construction machine having to stop a paving run, in particular the production of the paving layer from the paving material by the road paver and/or the supply of the road paver with the paving material by the feeder vehicle. Since the paving units of the road construction machine, such as the screed and material conveyor, usually have to be reheated after an interruption, the disclosure can optionally increase the energy efficiency of the road construction machine. Optionally, this can improve the quality of the paving layer.

The energy can be transmitted wirelessly, for example inductively. This means that an electrical magnetic field can be set up between the transmitting device and the receiving device, via which energy can be transmitted. The transmitting device can be configured to convert the electrical energy into electromagnetic energy and to transmit it wirelessly, in particular in a bundled form. The receiving device can be configured to convert the electromagnetic energy into electrical energy. The transmitting device and/or the receiving device can have a coil through which current can flow.

The electric drive may include a fuel cell. In addition to or instead of the electric drive, an internal combustion engine may be provided to drive the road construction machine. The choice of drive may depend on the type, location and/or duration of the road construction machine's intended use. With an electric drive, the road construction machine can be operated without directly emitting pollutants. Ideally, the road construction machine can be operated at a low noise level. This can be particularly advantageous if the road construction machine is only allowed to emit a limited amount of noise or pollutants, for example if it is to be operated in or near a populated area. Compared to an electric drive, an internal combustion engine can enable the road construction machine to operate at a relatively low cost over a long range. This can be particularly advantageous if there are no requirements for noise or pollutant limits, or if the road construction machine is to be operated over long distances without interruption.

The electrical consumer can be any consumer required for the use of the road construction machine. The consumer on the road paver can be, for example, an electrically operated lighting system, an electrically operated heating device, an electrically operated electro-hydraulic unit, an electrically operated control, operating and/or indicating device, an electrically operated longitudinal conveyor and/or an electrically operated transverse conveyor. For example, the consumer can be an electrically operated lighting system on the feeder vehicle, an electrically operated conveyor system for paving material and/or an electrically operated heating device of the feeder vehicle.

The road construction machine may further comprise a control device. The control device may be configured to control the operation of the road construction machine.

The receiving device may have an especially plate-shaped receiving antenna. This allows the receiving device to be configured in a particularly simple and cost-effective manner. Optionally, a particularly simple and especially reliable receiving of the electrical energy can be made possible. The receiving antenna can be mounted on an upper and/or lateral area of the road construction machine, for example on a driver's cab of a control station of the road construction machine. In particular, the receiving antenna can be exposed to the environment, i.e. not covered by components of the road construction machine. This can reduce interference when receiving electrical energy. The receiving antenna can have an area for receiving electrical energy of at least approx. 1 m², preferably at least approx. 1.5 m², and/or at most approx. 6 m², preferably at most approx. 3 m². A larger area can make it easier to receive electrical energy.

The wirelessly transmitted electrical energy may comprise a plurality of bundled, in particular high-frequency, electrical signals. This can enable targeted and, in particular, efficient supply of energy to the road construction machine. Ideally, atmospheric and scattering losses can be reduced. Optionally, a particularly safe transmission of energy can be made possible for living beings in the vicinity of the road construction machine, since little radiation is transmitted in the environment around the energy bundle. This can increase occupational safety. The frequency of the electrical signal may depend, in particular, on how many signals, i.e. how much energy, and/or how far and/or how fast the signal is to be transmitted. For example, the electrical signal may be in a range of at least about 80 kHz, preferably at least about 2 GHz, and/or at most about 30 GHZ, preferably at most about 10 GHz.

The electrical energy can be in the range of at least approx. 5 W, preferably at least approx. 150 W, and/or at most approx. 500 kW, preferably at most approx. 400 kW. This allows the road construction machine to be reliably supplied with the energy required for the paving operation, in particular for the electric drive and/or the consumer. The transmitted electrical energy can be scalable, in particular depending on the transmission distance, an energy requirement of the road construction machine, in particular the electric drive and/or the electrical consumer, and/or a charge level of a buffer storage device of the road construction machine, as described below. This means that, for example, energy can be transmitted with higher power when the road construction machine's energy requirement is increased.

The receiving device may be configured to wirelessly receive electrical energy during the paving run of the road construction machine. This allows the road construction machine to be supplied with electrical energy during the paving run. Ideally, it is possible to avoid stopping the road construction machine due to a lack of energy. Optionally, the receiving device can receive electrical energy wirelessly before and/or after the road construction machine has completed its paving run. The energy can then be forwarded, for example, to a buffer storage device as described below, where it is stored. During the paving run, the buffer storage device can then supply the road construction machine with electrical energy.

The road construction machine may comprise at least one rechargeable buffer storage device, wherein the buffer storage device is configured to receive and store electrical energy from the receiving device and to supply the electric drive and/or the electric consumer with electrical energy. Thus, the electric drive and/or the consumers can be supplied with energy by the receiving device indirectly via the buffer storage device. This enables reliable operation of the road construction machine during the paving run. The buffer storage device can increase the reliability of the road construction machine by allowing the road construction machine to be supplied with electrical energy via the receiving device and/or the buffer storage device. The buffer storage device can be a rechargeable battery, for example a battery. The buffer storage device can be a high-voltage storage device, in particular with several batteries, or a supercapacitor. Both the high-voltage storage device and the supercapacitor can be quickly charged and discharged, i.e. they can quickly provide energy to the road construction machine. Furthermore, supercapacitors in particular can be operated efficiently even at low ambient temperatures.

The buffer storage device can have a battery management system for monitoring and/or controlling the charging and/or discharging process, in particular of a cell current and/or a cell voltage and/or a cell temperature of the buffer storage device. The battery management system can monitor and/or control a charge level of the buffer storage device. The buffer storage device can have a minimum charge level and a maximum charge level. The minimum charge level can be approx. 10%, preferably approx. 15%. The maximum charge level can be approx. 100%, preferably approx. 98%. The battery management system can control the discharging of the buffer storage device in such a way that the charge level does not fall below the minimum charge level, which can lead to damage to the buffer storage device. The battery management system can control the charging of the buffer storage device in such a way that, when the maximum charge level is reached, the buffer storage device can no longer accept energy from the receiving device. The battery management system can control the charging of the buffer storage device in such a way that, when the charge level is below the maximum charge level, the buffer storage device can receive energy from the receiving device.

The road construction machine can initiate and/or end the charging process of the buffer storage device, in particular in an automated manner. In particular, the receiving device and/or the battery management system and/or the control device can initiate and/or end the charging process of the buffer storage device, in particular in an automated manner. Optionally, an operator of the road construction machine can manually initiate and/or end the charging process of the buffer storage device. The road construction machine, in particular the receiving device and/or the control device, and/or the transmitting device, in particular a control system, can initiate and/or end the receiving of electrical energy by means of the receiving device, in particular in an automated manner. Optionally, an operator of the road construction machine can manually initiate and/or end the receiving of electrical energy. The receiving device can simultaneously forward electrical energy to the electric drive and/or the consumer and/or the buffer storage device. The electric drive and/or the consumer can simultaneously be supplied with electrical energy from the receiving device and the buffer storage device, for example, if the energy provided by the receiving device is insufficient for the movement of the road construction machine and/or supply of the consumer or vice versa. The buffer storage device can simultaneously receive and release energy.

The road construction machine and the transmitting device can be communicatively connected to one another, in particular wirelessly. The receiving device and/or the battery management system and/or the control device and/or the electric drive and/or the consumer and/or a receiving position monitoring unit described below and/or an object detector described below and/or an energy forwarding device described below and/or an indicating device described below can be communicatively connected to one another, in particular wirelessly or via a cable.

The road construction machine may comprise a receiving position monitoring unit for monitoring a receiving device position and a transmitting device position. In particular, the road construction machine can be configured to determine a transmission distance for wirelessly transmitting electrical energy between the transmitting device position and the receiving device position. This allows the position of the road construction machine and the transmitting device, and in particular their distance from each other, to be monitored. This can support reliable operation of the road construction machine during the paving run. The receiving device can comprise the receiving position monitoring unit or be communicatively connected to it. The receiving position monitoring unit can comprise a position sensor, for example a GPS sensor, to determine the receiving device position. The receiving position monitoring unit can be configured to receive the transmitting device position from the transmitting device. The receiving device position can indicate a position of the receiving device, in particular of the receiving antenna. The transmitting device position can indicate a position of the transmitting device, in particular of the transmitting antenna. The transmission distance can indicate a distance between the transmitting device position and the receiving device position. The receiving device, in particular the receiving position monitoring unit, and/or the control device of the road construction machine can be configured to determine the transmission distance. The road construction machine can forward the receiving device position and/or the transmission distance to the transmitting device. The determined receiving device position and transmitting device position can be processed by the control device to actively control the position of the receiving device. This can increase the efficiency of the energy transmission. The determination of the receiving and transmitting device position can optionally be carried out based on the detection of a, preferably directed, guide signal of the road construction machine and/or the transmitting device within the transmitted energy bundle.

If the transmission distance corresponds at most to a maximum transmission distance, the receiving device can receive electrical energy. The maximum transmission distance can be at most about 1000 m, preferably at most about 500 m, preferably at most about 100 m. If the transmission distance is approx. 90%, preferably approx. 80%, of the maximum transmission distance, i.e. if the distance between the transmitting device position and the receiving device position is still small enough for the transmission of electrical energy, the receiving device can forward electrical energy to the buffer storage device. If the transmission distance exceeds the maximum transmission distance, i.e. if the road construction machine is too far away from the transmitting device for the energy to be transmitted, the road construction machine can be supplied with energy via the buffer storage device and continue or end the paving run. This increases the road construction machine's reliability. Optionally, the indicating device can output a message to the operator, a second road construction machine in the paving train, the transmitting device, a second transmitting device and/or an external construction site control system to indicate that energy transmission may no longer be possible with increasing transmission distance. This may be useful, for example, if the road construction machine quickly moves away from the transmitting device or, optionally, if the buffer storage device is very small or has a low energy capacity and/or can only be charged slowly.

The road construction machine may include an object detector for detecting an object in the transmission distance. This may ensure a reliable supply of electrical energy to the road construction machine. The receiving device, in particular the receiving position monitoring unit, can comprise the object detector or be communicatively connected to it. The object detector can comprise at least one radar, ultrasound or lidar sensor and/or a camera for detecting the object. The object detector can evaluate signal states of the received energy bundles in order to obtain information about detected objects. The object detector can forward information as to whether an object has been detected or not to the road construction machine and/or the transmitting device. If no object is detected in the transmission distance, the receiving device can receive electrical energy. If an object is detected in the transmission distance, the receiving device cannot receive electrical energy. The object detector can evaluate all signals, individual signals or individual signal ranges of the received energy bundle.

The road construction machine can have an indicating device to indicate an energy requirement of the road construction machine, in particular of the electric drive and/or the electric consumer, and optionally of the energy forwarding device. The indicating device can also be configured to display energy received by the receiving device and/or a charge level of the buffer storage device. The indicating device can also be configured to indicate the transmitting device position and/or the receiving device position and/or the transmission distance and/or a detected object. The display may be visual and/or acoustic. The indicating device may also be configured to receive manual input from the operator and forward it to the control device. For example, the indicating device may include a screen, a touchpad, an enter button, an input switch, and/or a speaker.

The road construction machine may include an energy forwarding device for wirelessly forwarding the electrical energy from the receiving device and/or the buffer storage device to a second road construction machine. In principle, the energy forwarding device can wirelessly forward electrical energy to any unit with a receiving device compatible with the energy forwarding device. This allows the road construction machine to release excess energy. Furthermore, the range and/or operating time of the second road construction machine and, in particular, its reliability can be increased. The energy forwarding device can have a forwarding antenna for wirelessly transmitting the electrical energy to the second road construction machine, in particular a second receiving device, preferably a second receiving antenna. The forwarding antenna can be plate-shaped or rod-shaped. The forwarding antenna can be mounted on an upper and/or lateral area of the road construction machine. In particular, the forwarding antenna can be exposed to the environment, i.e. not covered by components of the road construction machine. For example, the forwarding antenna can be mounted on the driver's cab of the control stand of the road construction machine. This can reduce interference when transmitting the electrical energy. To transmit the electrical energy from the buffer storage device to the energy forwarding device, they can be connected by a cable. While the receiving device of the road construction machine is receiving electrical energy from the transmitting device and/or forwarding it to the electric drive and/or the consumer and/or the buffer storage device, the energy forwarding device can simultaneously forward electrical energy to the second road construction machine.

According to another embodiment of the disclosure, a system for wirelessly supplying a first road construction machine with electrical energy is provided. The system includes a first road construction machine having a first receiving device for wirelessly receiving electrical energy. The system further comprises an external transmitting device for wirelessly transmitting electrical energy to the first receiving device. The system further comprises an energy source for supplying the transmitting device with electrical energy. This allows for easy supply of the first road construction machine with electrical energy. Reliable operation of the first road construction machine during the paving run can be ensured.

The transmitting device can be electrically connected to the energy source, in particular by means of a cable. The transmitting device can comprise a control system for controlling the operation of the transmitting device. The transmitting device, in particular the control system, can be communicatively connected to the energy source.

The energy source can be, for example, a local energy distribution network. Optionally, the energy source can be a wind, solar, or hydroelectric power plant or a combustion engine, in particular with a generator.

The transmitting device may be stationary or mobile. In particular, a mobile transmitting device can increase the range and/or duration of use of the first road construction machine. The mobile transmitting device can be moved with the first road construction machine. This can ensure that the transmission distance is small enough for an energy transmission. For example, the transmitting device can be mounted on a mobile vehicle. Optionally, the mobile vehicle can comprise the energy source. For example, the mobile vehicle can have an energy storage device that provides the transmitting device with the energy to be transmitted. Optionally, the mobile vehicle can generate the electrical energy itself, in particular by means of an internal combustion engine and generator. The system can comprise several transmitting devices for supplying the first road construction machine with energy. For example, several stationary transmitting devices can be provided at a construction site. This can ensure that the first road construction machine is close enough to at least one of the several transmitting devices for the energy transmission. The control system of the transmitting device and/or the control system of the road construction machine can assign the one or more transmitting devices to the road construction machine, for example based on the current location and/or operating status of the road construction machine and/or the transmitting device(s). This can increase the efficiency of the energy transmission and, optionally, of the road construction machine.

The transmitting device may comprise a transmitting antenna and the first receiving device comprises a first receiving antenna, wherein the transmitting antenna is rotatably mounted with respect to the transmitting device and/or the first receiving antenna is rotatably mounted with respect to the first road construction machine in order to align the transmitting antenna and the first receiving antenna with respect to each other. This allows for a particularly simple and, in particular, reliable transmission of electrical energy. The rotation may include or constitute tilting. To rotate the transmitting antenna and/or the first receiving antenna, a pivot joint may be provided between the transmitting antenna and the transmitting device and/or between the first receiving antenna and the first road construction machine. The transmitting antenna and/or the first receiving antenna can be rotated about at least one pivot axis. The transmitting antenna and/or the first receiving antenna can be rotated about at least 30°, preferably about at least 60°, and/or about at most 360°, in particular in both directions, about the pivot axis. The transmitting antenna can, for example, be plate-shaped or rod-shaped. The transmitting antenna can be mounted in an upper and/or lateral area of the transmitting device. For example, the transmitting antenna can be mounted on the roof of a mobile vehicle. In particular, the transmitting antenna can be exposed to the environment, i.e. not covered by components of the transmitting device and in particular of the mobile vehicle. This can reduce interference when transmitting electrical energy. The transmitting antenna can be communicatively connected to the control system.

A distance between the transmitting device, in particular the transmitting antenna, and the first receiving device, in particular the first receiving antenna, may be at most approx. 1000 m, preferably at most approx. 500 m, preferably at most approx. 100 m, and/or a speed of the first road construction machine relative to the transmitting device during the reception of electrical energy is at most approx. 20 m/min, preferably at most approx. 6 m/min. In particular, the road construction machine and the transmitting device can move at approx. the same, in particular constant, speed and/or at a constant distance from each other. This can enable reliable transmission of electrical energy. The distance between the transmitting device, in particular a transmitting device position, and the first receiving device, in particular a first receiving device position, can indicate a transmission distance. If the first road construction machine moves at a speed of at most the above speed and at most at the distance from the transmitting device, it can be ensured that the first road construction machine does not move so far or fast away from the transmitting device that the transmission distance becomes too great for an energy transmission. The transmitting device can comprise a position sensor, for example a GPS sensor, to determine the transmitting device position. The position sensor can be communicatively connected to the control system.

The system may include a second road construction machine having a second receiving device for wirelessly receiving electrical energy, wherein the first road construction machine has an energy forwarding device for wirelessly forwarding the electrical energy from the first receiving device and/or the buffer storage device to the second road construction machine. This can increase the range and/or duration of use of the second road construction machine and, in particular, its reliability. The second road construction machine can be substantially the same or similar in structure to the first road construction machine. The first road construction machine and the second road construction machine can be communicatively connected to one another, in particular in a wireless manner. The first and/or the second road construction machine can initiate and/or end the energy transmission. The second receiving device can be configured to receive electrical energy from the transmitting device and/or the first road construction machine. The second road construction machine can have a second receiving position monitoring unit for monitoring a second receiving device position of the second road construction machine and a forwarding position of the first road construction machine. The first road construction machine may comprise a forwarding position monitoring unit for monitoring the forwarding position of the first road construction machine and a second receiving device position of the second road construction machine. The second receiving position monitoring unit may comprise a position sensor, for example a GPS sensor, for determining the second receiving device position. The forwarding position monitoring unit may comprise a position sensor, for example a GPS sensor, for determining the forwarding position. The second road construction machine and/or the first road construction machine can be configured to determine a second transmission distance for wireless transmission of electrical energy. The second transmission distance can be a distance between the forwarding position and the second receiving device position. The road construction machine can transmit energy to the second road construction machine under the condition that a second transmission distance between the road construction machine and the second road construction machine corresponds at most to a second maximum transmission distance. The second maximum transmission distance can be at most approx. 200 m, preferably at most approx. 50 m. For the energy transmission, it can be particularly advantageous that the first road construction machine and the second road construction machine do not move away from each other too fast. The speed of the first road construction machine relative to the second road construction machine can be at most approx. 150 m/min, preferably at most approx. 6 m/min. The first road construction machine and the second road construction machine can in particular move at approximately the same, in particular constant, speed and/or at a constant distance from each other. Optionally, the road construction machine can transmit energy to the second road construction machine on condition that the charge level of the buffer storage device of the road construction machine is at least approx. 70%, preferably at least approx. 80%, of the maximum charge level. The energy transmission from the first road construction machine to the second road construction machine can be particularly advantageous if the second road construction machine is not within range of a transmitting device, i.e. cannot be supplied with energy by it. In this case, the first road construction machine can supply the second road construction machine with electrical energy until the second road construction machine is within range of a transmitting device again.

According to another embodiment of the disclosure, a method for operating a road construction machine is provided. The method comprises the steps of: supplying an external transmitting device arranged outside the road construction machine with electrical energy by means of an energy source; wirelessly transmitting the electrical energy from the transmitting device to a receiving device of the road construction machine; forwarding the electrical energy from the receiving device to an electric drive and/or at least one electrical consumer of the road construction machine; and moving the road construction machine by means of the electric drive and/or operating the electrical consumer by means of the electrical energy.

The road construction machine may include a buffer storage device for storing electrical energy, wherein the receiving device forwards the electrical energy to the buffer storage device, wherein the buffer storage device forwards the electrical energy to the electric drive and/or the electric consumer.

The features or explanations described for one of the embodiments of the disclosure (road construction machine, system or method) may be applied individually or in combination to the other embodiments and combined with them.

### BRIEF DESCRIPTION OF THE DRAWINGS

In the following, the disclosure is explained by means of exemplary embodiments.

It is shown by:

FIG. 1 a perspective view of a road construction machine in the form of a road paver according to an embodiment;

FIG. 2 a perspective view of a road construction machine in the form of a feeder vehicle according to an embodiment;

FIG. 3 a first system for wirelessly supplying a road paver with electrical energy according to one embodiment;

FIG. 4 the first system at a first point in time of the paving run;

FIG. 5 the first system at a second point in time of the paving run;

FIG. 6 the first system at a third point in time of the paving run;

FIG. 7 a second system for wirelessly supplying a road paver and a feeder vehicle with electrical energy according to a further embodiment;

FIG. 8 the second system at a first point in time of the paving run; and

FIG. 9 the second system at a second point in time of the paving run.

### DETAILED DESCRIPTION

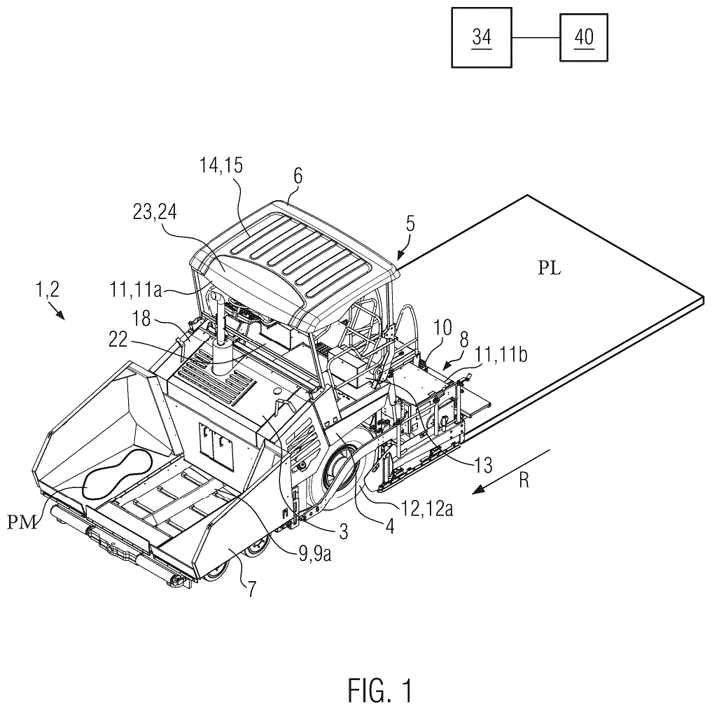

FIG. 1 shows a perspective view of a road construction machine 1 in the form of a road paver 2 according to one embodiment. The road paver 2 is configured to produce a paving layer PL from paving material (e.g. asphalt mix) PM. The road paver 2 is self-propelled in a direction of travel R.

The road paver 2 further comprises a chassis 4, a control stand 5 for an operator of the road paver 2, a driver's cab 6 and a material hopper 7 for holding the paving material PM. Furthermore, a height-adjustably supported paving screed 8, which is towed in the direction of travel R, and a conveyor unit 9, comprising a conveyor belt 9a, are attached to the chassis 4, to make the paving material PM from the material hopper 7 of the road paver 2 available to the paving screed 8 by a transverse distribution device 10 of the road construction machine 1.

FIG. 1 also shows two examples of electrical consumers 11 of the road paver 2. A first electrical consumer 11a is a lighting system for illuminating the surrounding area or the control stand 5. A second electrical consumer 11b is a heating device for heating the paving screed 8. The paving screed 8 includes components, such as compaction units (screed plates, tamper and pressure bars (not shown). The action of the weight of the compaction unit compacts the paving material PM. To prevent the paving material PM from sticking to the components of the paving screed 8, heating devices (not shown), usually electrical heating assemblies, can be integrated into these components.

In order to move in the direction R, the road paver 2 has a wheeled chassis 12 with two driven wheels 12a. The road paver 2 also has an electric drive 3 to drive the wheeled chassis 12. With the electric drive 3, the road paver 2 can be operated without directly emitting pollutants. Ideally, the road paver 2 can be operated quietly. This is particularly advantageous if the road paver 2 is only allowed to emit a limited amount of noise or pollutants, for example if it is to be operated in or near a populated area. The electric drive 3 is configured to drive the wheeled chassis 12 in such a way that the wheeled chassis 12 moves the road paver 2 in the direction of travel R. For this purpose, the electric drive 3 and the wheeled chassis 12 are mechanically connected to one another.

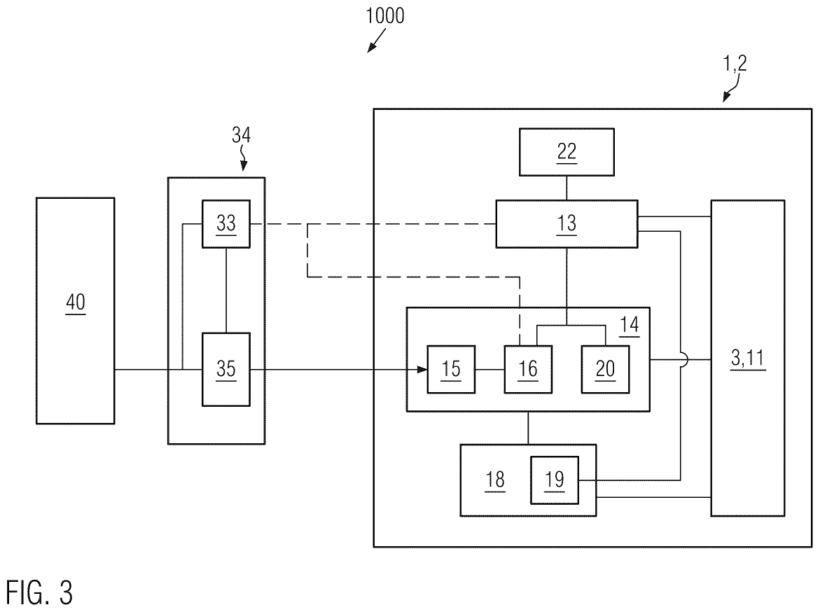

For supplying the electric drive 3 and the consumers 11 with electrical energy, the road paver 2 has a first receiving device 14 and a buffer storage device 18 (see FIG. 3). Furthermore, the road paver 2 comprises a first control device 13 for controlling the road paver 2 and a first indicating device 22. The wheeled chassis 12, the electric drive 3, the consumers 11, the first receiving device 14, the buffer storage device 18, the first control device 13 and the first indicating device 22 are communicatively connected to one another via a cable.

In the following, the supply of electrical energy to the road paver 2 and the function of the above-mentioned components are described with reference to a first system 1000 as shown in FIG. 3.

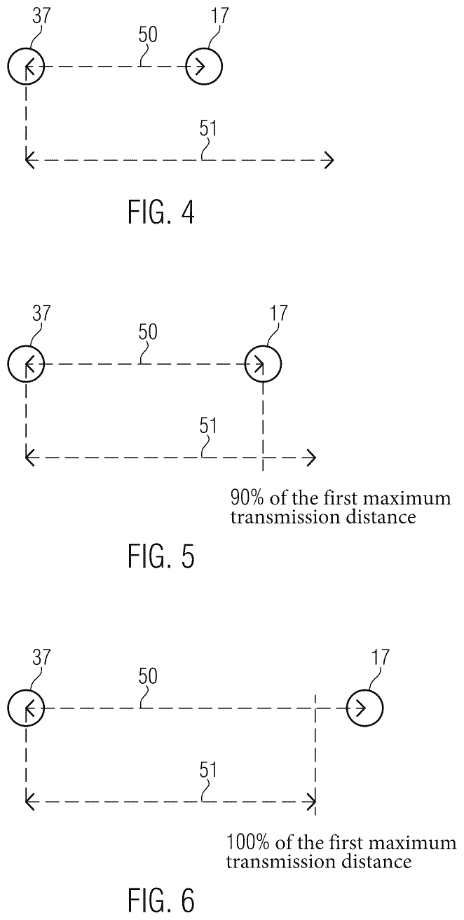

The first system 1000 includes the road paver 2, an external transmitting device 34 and an energy source 40. A wireless connection between one or more components of the system is shown as a dashed line in FIGS. 4 to 9. A wired connection is shown as a solid line, also in FIGS. 4 to 9. An arrow indicates a transmission direction, also in FIGS. 4 to 9, wherein a connection without an arrow allows transmission in both directions.

During a paving run at a construction site, the road paver 2 wirelessly receives electrical energy from a transmitting antenna 35 of the transmitting device 34 through the first receiving device 14. The wireless energy transmission makes it particularly easy to supply the road paver 2 with electrical energy. Furthermore, an extension of the operating time and range of the road paver 2 is achieved. Ideally, this avoids having to stop the paving run of the road paver 2 due to a lack of energy. This ideally improves the quality of the paving layer PL.

For receiving the electrical energy, the first receiving device 14 has a first plate-shaped receiving antenna 15 with an area for receiving electrical energy of approx. 1.5 m². The first receiving antenna 15 is mounted on the driver's cab 6 so that it is exposed to the environment, i.e. the first receiving antenna 15 is not covered by components of the road paver 2 (see FIG. 1). This enables particularly simple and reliable receiving of the electrical energy. Interference during the receiving of the electrical energy is reduced and thus the energy transmission is improved.

The energy source 40 supplies the transmitting device 34 with the electrical energy to be transmitted. For this purpose, the energy source 40 is configured as a local energy distribution network and is electrically and communicatively connected to the transmitting device 34 via a cable.

The first control device 13 controls the energy transmission from the transmitting device 34 to the road paver 2. In order to transmit energy from the transmitting device 34 to the road paver 2, it is necessary that they are not too far away from one another. In order to determine whether energy transmission is possible, a first receiving position monitoring unit 16 of the receiving device 14 determines a first receiving device position 17 of the first receiving device 14 by means of an integrated GPS sensor. The transmitting device 34 determines a transmitting device position 37 of the transmitting device 34 by means of a GPS sensor and forwards it to the first receiving position monitoring unit 16 by means of a control system 33. Based on the transmitting device position 37 and the first receiving device position 17, the first receiving position monitoring unit 16 determines a first transmission distance 50 between the transmitting device position 37 and the first receiving device position 17 (see FIG. 4). In the present embodiment, the first transmission distance 50 is approx. 300 m. The first receiving position monitoring unit 16 compares the first transmission distance 50 with a stored first maximum transmission distance 51 of approx. 500 m, up to which energy can be transmitted. In the present case, the first transmission distance 50 is shorter than the first maximum transmission distance 51. The first receiving position monitoring unit 16 forwards this information to the first control device 13.

Furthermore, electrical energy can be transmitted if there is no object 21 in the first transmission distance 50. This is determined by means of a first object detector 20 of the receiving device 14, which comprises a radar sensor. In the present case, no object 21 is detected. The object detector 20 forwards information that no object 21 has been detected to the first control device 13 via a cable.

Furthermore, the first control device 13 receives information from the electric drive 3 and the consumers 11 about their energy requirements during the paving run.

Based on the first transmission distance 50, the information about the non-detected object 21 and the energy requirement, the first control device 13 initiates the energy transmission from the transmitting device 34 to the first receiving device 14. For this purpose, the first control device 13 communicates wirelessly with a control system 33 of the transmitting device 34, whereupon the latter causes the transmitting antenna 35 to send electrical energy to the receiving antenna 15 of the road paver 2. The energy is transmitted in the form of several bundled electrical signals with a frequency of approx. 2.5 GHz and a power of approx. 150 KW. This enables a targeted and sufficient supply of electrical energy to the road paver 2, in particular without major transmission losses. The first receiving device 14 transmits the received energy directly to the electric drive 3 and the consumers 11 via a cable in order to operate them.

In the first system 1000, the transmitting device 34 is provided to be stationary at the construction site, in contrast to the moving road paver 2. This means that road paver 2 moves away from the transmitting device 34, in particular at a speed of approx. 6 m/min. Therefore, the first transmission distance 50 increases with advancing paving run of the road paver 2 (see FIGS. 5 to 6). If the first transmission distance 50 exceeds the first maximum transmission distance 51, the road paver 2 would be too far away from the first transmitting device 34 for an energy transmission, so that the road paver 2 can no longer receive any energy. In order to avoid the road paver 2 having to interrupt or end the paving run, the first receiving device 14 is configured to forward part of the electrical energy received from the transmitting device 34 to the buffer storage device 18, which is configured as a supercapacitor, so that it can indirectly supply the road paver 2 with energy. The buffer storage device 18 is charged via the receiving device 14 under the conditions, that the first transmission distance 50 is at least 90% of the first maximum transmission distance 51 and the charge level of the buffer storage device 18 is less than the maximum charge level of 100%.

For the second point in time of the paving run shown in FIG. 5, the first receiving position monitoring unit 16 determines a first transmission distance 50 of approx. 450 m. This corresponds to 90% of the first maximum transmission distance 51. A battery management system 19 of the buffer storage device 18 determines a charge level of approx. 50%. Based on this information, the first control device 13 causes the first receiving device 14 to forward electrical energy to the buffer storage device 18 via a cable, as a precaution, so to speak. To charge the buffer storage device 18, the control device 13 communicates with the battery management system 19. The battery management system 19 controls the charging and discharging of the buffer storage device 18 in such a way that damage to the buffer storage device 18 is avoided and its longevity is increased.

In FIG. 6, the first transmission distance 50 is greater than the first maximum transmission distance 51, i.e., the road paver 2 is too far away from the transmitting device 34 for the energy transmission. At this third point in time of the paving run, the buffer storage device 18 transmits the stored electrical energy to the electric drive 3 and the consumers 11 via a cable, so that the road paver 2 can continue and, in particular, end its paving run.

During the paving run, the first indicating device 22 visually informs the operator about the operation of the road paver 2 (see FIG. 1). For this purpose, the indicating device 22 is configured as a display. The indicating device 22 provides information about whether the road paver 2 is supplied with energy directly by the first receiving device 14, as in FIG. 4, and/or indirectly via the buffer storage device 18, as shown in FIG. 6. If the direct energy supply of the road paver 2 by the first receiving device 14 is at risk and, in particular, the buffer storage device 18 is being charged as a precaution, as shown in FIG. 5, the operator can also see this from the indicating device 22 at an early stage.

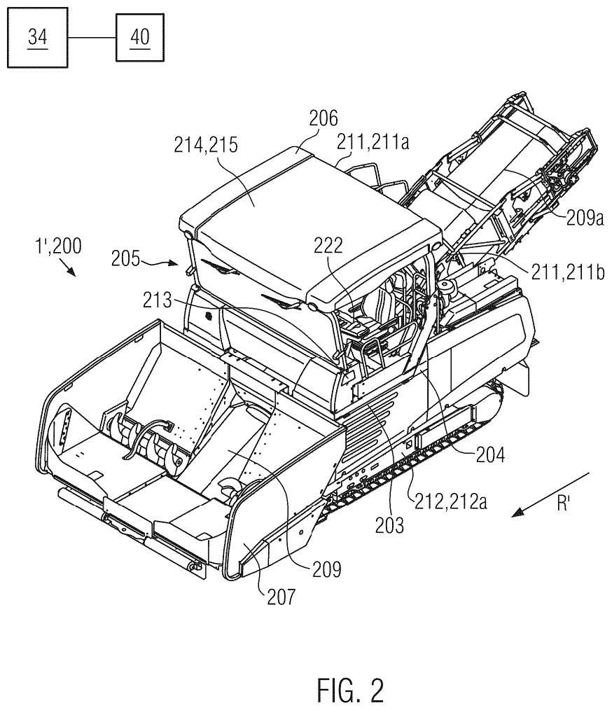

FIG. 2 shows a second road construction machine 1′ in perspective view, which is a feeder vehicle 200 for conveying paving material PM to a road paver 2 travelling behind. The feeder vehicle 200 is self-propelled in a direction of travel R′.

The feeder vehicle 200 comprises a chassis 204, a control station 205, a driver's cab 206, a material hopper 207 for holding a paving material PM, and a conveyor unit 209 comprising a conveyor belt 209a, to transport the paving material PM from the material hopper 207 of the feeder vehicle 200 into the material hopper 7 of the road paver 2.

The feeder vehicle 200 also has two electrical consumers 211. The first electrical consumer 211a is a lighting system for illuminating the surrounding area or the control stand 205. A second electrical consumer 211b is a heating device for heating the conveyor belt 209a.

The feeder vehicle 200 is moved by means of a caterpillar chassis 212 with two driven chains 212a. An internal combustion engine 203 is connected to the caterpillar chassis 212 in a hydro-mechanical manner in order to drive it. The combustion engine 203 enables the feeder vehicle 200 to be operated economically at a relatively long range compared to an operation with an electric drive. This is particularly advantageous when there are no requirements for noise or pollutant limits or when the feeder vehicle 200 is to be operated over long distances without interruption.

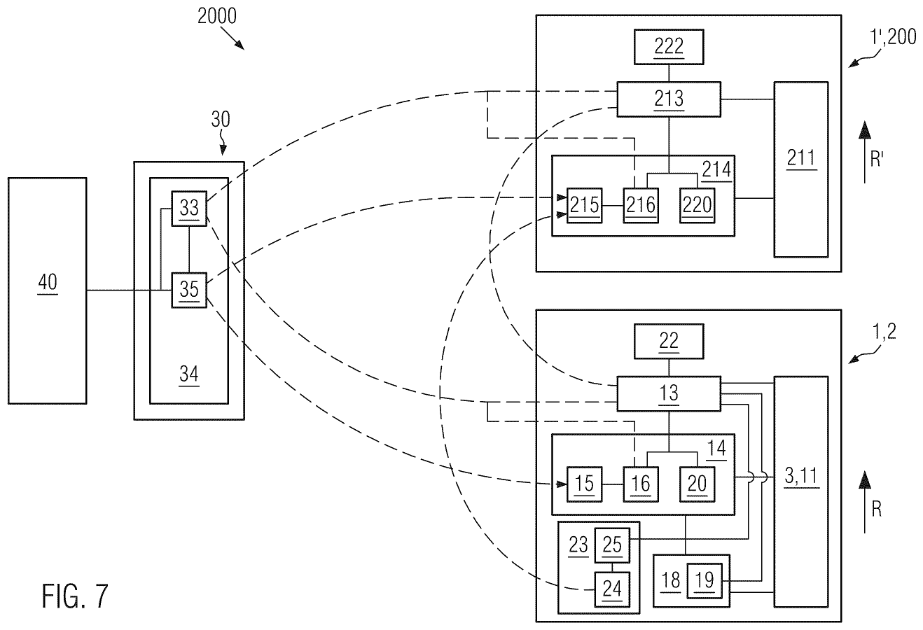

The feeder vehicle 200 also has a second receiving device 214, which is built substantially identically to the first receiving device 14. For example, the second receiving device 214 has a second receiving antenna 215, a second receiving position monitoring unit 216 and a second object detector 220 (see FIG. 7). In contrast to the road paver 2, the second receiving device 214 only supplies the consumers 211 with electrical energy. The feeder vehicle 200 further does not comprise a buffer storage device 18, which allows the free space to be used for an enlarged internal combustion engine 203. This further increases the operating time and range of the feeder vehicle 200.

Furthermore, the feeder vehicle 200 comprises a second control device 213 for controlling the feeder vehicle 200 and a second indicating device 222, each of which has essentially the same structure as in the road paver 2. The consumers 211, the second receiving device 214, the second control device 213 and the second indicating device 222 are communicatively connected to one another via a cable.

FIGS. 7 to 9 show a second system 2000 for wirelessly supplying a road paver 2 and a feeder vehicle 200 with electrical energy. The second system 2000 comprises a road paver 2, a feeder vehicle 200, a transmitting device 34 and an energy source 40. The energy source 40 and the feeder vehicle 200 correspond to the energy source 40 and the feeder vehicle 200 described above.

The transmitting device 34 corresponds to the aforementioned transmitting device 34, however, it is configured to be mobile. For this purpose, the transmitting device 34 is mounted on a mobile vehicle 30. For reliable energy transmission, the transmitting antenna 35 of the transmitting device 34 is mounted on a vehicle roof of the mobile vehicle 30. While the road paver 2 and the feeder vehicle 200 are moving, the mobile vehicle 30 also moves relative to them, in particular with them in the direction of travel R, R′.

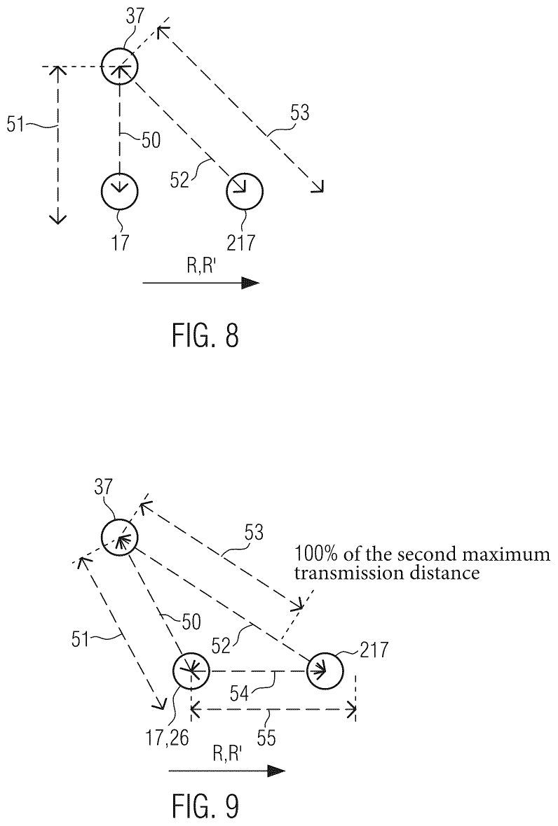

The road paver 2 and the feeder vehicle 200 each move relative to the mobile vehicle 30 at a constant speed of approx. 4 m/min. Therefore, the first transmission distance 50 between the road paver 2, in particular the first receiving device position 17, and the transmitting device 34, in particular the transmitting device position 37, as well as a second transmission distance 52 between the feeder vehicle 200, in particular a second receiving device position 217, and the transmitting device 34, in particular the transmitting device position 37, increases with advancing travel (see FIGS. 8 and 9). By the transmitting device 34 being mobile, it is, however, achieved that the road paver 2 and the feeder vehicle 200 move away from it more slowly than from a stationary transmitting device 34. This makes it possible to supply the road paver 2 and the feeder vehicle 200 with energy wirelessly for a longer time, in particular as long as the first transmission distance 50 and/or the second transmission distance 52 corresponds at most to the first maximum transmission distance 51 or the second maximum transmission distance 53. In the present embodiment, the second maximum transmission distance 53 corresponds to the first maximum transmission distance 51 of approx. 500 m.

FIG. 8 shows the road paver 2, the feeder vehicle 200 and the transmitting device 34 at a first point in time of the paving run. The first and second transmission distances 50, 52 are shorter than the first and second maximum transmission distances 51, 53, respectively, so that the transmitting device 34 wirelessly transmits energy to the road paver 2 and the feeder vehicle 200. At this point in time, the road paver 2 supplies the electric drive 3 and the consumers 11 with electrical energy directly, in the same way as the feeder vehicle 200 does with the consumers 211.

FIG. 9 shows the road paver 2, the feeder vehicle 200 and the transmitting device 34 at a second point in time of the paving run. The first transmission distance 50 between the road paver 2 and the transmitting device 34 is still small enough for the energy transmission. This means that the first receiving device 14 receives wireless energy from the transmitting device 34 and the road paver 2 supplies the electric drive 3 and the consumers 11 directly with electrical energy.

In contrast, the second transmission distance 52 between the feeder vehicle 200 and the transmitting device 34 is too great for the energy transmission. However, the feeder vehicle 200 does not comprise a buffer storage device 18 (see FIG. 7). This means that the feeder vehicle 200, in particular the consumers 211, can only be supplied with energy directly via the second receiving device 214. To enable the feeder vehicle 200 to continue its paving run nevertheless, the feeder vehicle 200 is configured to receive energy wirelessly from the road paver 2 traveling behind. For this purpose, the road paver 2 has an energy forwarding device 23 with a plate-shaped forwarding antenna 24 (see FIG. 7). The forwarding antenna 24 is mounted in an exposed position on a front side of the driver's cab 6 of the road paver 2 in the direction of the second receiving device 214 of the feeder vehicle 200 traveling in front (see FIG. 1), and is connected to the buffer storage device 18 via a cable in order to obtain the electrical energy to be transmitted from the buffer storage device.

At the point in time shown in FIG. 9, the second control device 213 of the feeder vehicle 200 initiates the wireless energy transmission from the road paver 2 to the feeder vehicle 200 under the conditions that a third transmission distance 54 between the road paver 2 and the feeder vehicle 200 corresponds at most to a third maximum transmission distance 55 of 100 m and the charge level of the buffer storage device 18 of the road paver 2 is at least 80% of the maximum charge level.

To determine the third transmission distance 54, the energy forwarding device 23 has a forwarding position monitoring unit 25 (see FIG. 7). This determines, by means of an integrated GPS sensor, a forwarding position 26 that corresponds approx. to the first receiving device position 17 (see FIG. 9). The road paver 2 sends the forwarding position 26 to the second receiving position monitoring unit 216 of the feeder vehicle 200. The second receiving position monitoring unit 216 also has a GPS sensor, and uses this to determine a second receiving device position 217 of the second receiving device 214. Based on the forwarding position 26 and the second receiving device position 217, the second receiving position monitoring unit 216 determines the third transmission distance 54 of 20 m, which is thus smaller than the third maximum transmission distance 55. The second receiving position monitoring unit 216 forwards this information to the second control device 213. Furthermore, the first control device 13 forwards information about the charge level of the buffer storage device 18 of the road paver 2 of 100% to the second control device 213. Furthermore, the second control device 213 receives information from the consumers 211 about their energy requirements during the paving run. Based on the third transmission distance 54, the charge level of the buffer storage device 18 and the energy requirement, the second control device 213 initiates the energy transmission from the road paver 2 to the feeder vehicle 200. For this purpose, the second control device 213 of the feeder vehicle 200 communicates wirelessly with the first control device 13 of the road paver 2. The road paver 2 transmits sufficient electrical energy to the feeder vehicle 200 via the forwarding antenna 24 for a sufficient amount of time so that the feeder vehicle 200 can continue and, in particular, end its paving run together with the road paver 2.

As one skilled in the art would understand, the control stand or station 5, first control device 13, first receiving device 14, first receiving position monitoring unit 16, buffer storage device 18, battery management system 19, object detector 20, first indicating device 22, energy forwarding device 23, forwarding position monitoring unit 25, control system 33, transmitting device 34, control stand or station 205, second control device 213, second receiving device 214, second receiving position monitoring unit 216, second indicating device 222, as well an any other device, control, controller, unit, system, detector, sensor, machine, apparatus, clement, component, subsystem, arrangement, or the like described herein may individually, collectively, or in any combination comprise appropriate circuitry, such as one or more appropriately programmed processors (e.g., one or more microprocessors including central processing units (CPU)) and associated memory which may include stored operating system software and/or application software executable by the processor(s) for controlling operation thereof and/or for performing the particular algorithms represented by the various functions and/or operations described herein, including interaction and/or cooperation between any such system, unit, controller, machine, apparatus, element, sensor, detector, device, component, subsystem, arrangement, or the like. One or more of such processors, as well as other circuitry and/or hardware, may be included in a single component (e.g., an ASIC (Application-Specific Integrated Circuit)), or several processors and various circuitry and/or hardware may be distributed among several separate components, whether individually packaged or assembled into a SoC (System-on-a-Chip).

What is claimed is:

1. A road construction machine comprising:
an electric drive for driving the road construction machine and/or at least one electrical consumer, and
a receiving device for electrical energy, wherein the receiving device is configured to wirelessly receive electrical energy from an external transmitting device and to forward the electrical energy to the electric drive and/or the at least one electric consumer.

2. The road construction machine according to claim 1, wherein the receiving device has a receiving antenna which is plate-shaped.

3. The road construction machine according to claim 1, wherein the wirelessly transmitted electrical energy comprises a plurality of bundled electrical signals.

4. The road construction machine according to claim 1, wherein the receiving device is configured to receive electrical energy wirelessly during a paving run of the road construction machine.

5. The road construction machine according to claim 1, further comprising at least one rechargeable buffer storage device, wherein the rechargeable buffer storage device is configured to receive and store electrical energy from the receiving device and to supply the electric drive and/or the electric consumer with electrical energy.

6. The road construction machine according to claim 1, further comprising a receiving position monitoring unit for monitoring a receiving device position and a transmitting device position,
wherein the road construction machine is configured to determine a transmission distance for wirelessly transmitting electrical energy between the transmitting device position and the receiving device position.

7. The road construction machine according to claim 6, further comprising an object detector for detecting an object in the transmission distance.

8. The road construction machine according to claim 5, further comprising an energy forwarding device for wirelessly forwarding the electrical energy from the receiving device and/or the at least one rechargeable buffer storage device to a second road construction machine.

9. A system for wirelessly supplying a first road construction machine with electrical energy, comprising:
a first road construction machine comprising a first receiving device for wirelessly receiving electrical energy,
an external transmitting device for wirelessly transmitting electrical energy to the first receiving device, and
an energy source for supplying the external transmitting device with electrical energy.

10. The system according to claim 9, wherein the transmitting device is stationary or mobile.

11. The system according to claim 9, wherein the transmitting device has a transmitting antenna and the first receiving device has a first receiving antenna, wherein the transmitting antenna is rotatably mounted with respect to the transmitting device and/or the first receiving antenna is rotatably mounted with respect to the first road construction machine in order to align the transmitting antenna and the first receiving antenna with respect to one another.

12. The system according to claim 9 wherein a distance between the transmitting device, comprising the transmitting antenna, and the first receiving device, comprising the first receiving antenna, is at most approximately 1000 m and/or a speed of the first road construction machine relative to the transmitting device during the receiving of electrical energy is at most approximately 20 m/min.

13. The system according to claim 9 wherein a second road construction machine having a second receiving device for wirelessly receiving electrical energy, wherein the first road construction machine comprises an energy forwarding device for wirelessly forwarding the electrical energy from the first receiving device and/or the rechargeable buffer storage device to the second road construction machine.

14. A method for operating a road construction machine, comprising:
supplying an external transmitting device, which is arranged outside the road construction machine, with electrical energy via an energy source,
wirelessly transmitting the electrical energy from the external transmitting device to a receiving device of the road construction machine,
forwarding the electrical energy from the receiving device to an electric drive of the road construction machine and/or to at least one electric consumer of the road construction machine, and
moving the road construction machine via the electric drive and/or operating the at least one electrical consumer via the electrical energy.

15. The method according to claim 14, wherein the road construction machine comprises a buffer storage device for storing electrical energy, wherein the receiving device forwards the electrical energy to the buffer storage device, wherein the buffer storage device forwards the electrical energy to the electric drive and/or the electric consumer.

16. The road construction machine according to claim 1, wherein the road construction machine comprises a road paver for producing a paving layer from a paving material or a feeder vehicle for supplying the road paver with paving material.

17. The road construction machine according to claim 1, wherein the wirelessly transmitted electrical energy comprises a plurality of bundled high-frequency electrical signals.

18. The system according to claim 12 wherein the distance between the transmitting device, comprising the transmitting antenna, and the first receiving device, comprising the first receiving antenna, is at most approximately 500 m and/or the speed of the first road construction machine relative to the transmitting device during the receiving of electrical energy is at most approximately 6 m/min.

19. The system according to claim 12 wherein the distance between the transmitting device, comprising the transmitting antenna, and the first receiving device, comprising the first receiving antenna, is at most approximately 100 m and/or the speed of the first road construction machine relative to the transmitting device during the receiving of electrical energy is at most approximately 20 m/min.

20. The system according to claim 12 wherein the distance between the transmitting device, comprising the transmitting antenna, and the first receiving device, comprising the first receiving antenna, is at most approximately 100 m and/or the speed of the first road construction machine relative to the transmitting device during the receiving of electrical energy is at most approximately 6 m/min.
